(19) United States
(12) Patent Application Publication
(10) Pub. No.: US 2007/0244680 A1
(43) Pub. Date: Oct. 18, 2007

(54) Turbulence modeling using unstructured mesh system

(76) Inventor: Mingde Su, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/402,604

(22) Filed: Apr. 12, 2006

(51) Int. Cl. G06G 7/48

(52) U.S. Cl. 703/9; 703/10

(57) ABSTRACT

A method for stimulated modeling includes measuring filtered values of fluid-flow variables for an object. The method includes stimulating unfiltered values of the fluid-flow variables based on the filtered values, calculating correlations of differences between the filtered values and the unfiltered values, and calculating components of Reynolds stress based on the correlations. The method includes predicting effects of fluid-flow on the object based on the components of Reynolds stress.

### FIELD OF THE INVENTION

The present invention relates to turbulence modeling, and more specifically to stimulated modeling using unstructured mesh system.

### BACKGROUND OF THE INVENTION

Predicting effects of airflow on a vehicle and vehicle components is important in predicting aerodynamic performance of the vehicle while the vehicle is in motion. For example, air resistance may impact fuel economy and stability of the vehicle. Additionally, airflow may impact NVH (noise, vibration, and harshness) parameters of the vehicle such as wind noise, vibrations of outside mirrors, antennas, front grills, underbody structures etc.

Turbulence modeling is used to predict effects of fluid-flow on an object. For example, effects of airflow on aircrafts and vehicles, effects of flow of water on submarines etc. can be predicted using simulations based on turbulence modeling. Conventional turbulence modeling uses viscous coefficients and approximations to calculate Reynolds stresses and components of Reynolds stresses. More specifically, conventional models use hypotheses and empirical parameters that vary depending on the problem that is being analyzed. This limitation restricts the general applicability of these models. New non-Eddy viscous turbulence models are capable of simulating turbulence without using hypotheses and empirical parameters. Presently, however, these models can be used only in structured mesh systems.

### SUMMARY OF THE INVENTION

A method for stimulated modeling includes measuring filtered values of fluid-flow variables for an object, stimulating unfiltered values of the fluid-flow variables based on the filtered values, calculating correlations of differences between the filtered values and the unfiltered values, calculating components of Reynolds stress based on the correlations, and predicting effects of fluid-flow on the object based on the components of the Reynolds stress.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a method for stimulating unfiltered values according to the present invention;

FIG. 2 shows an unstructured mesh system; and

FIG. 3 is a flowchart for an algorithm for stimulated modeling according to the present invention.

### DETAILED DESCRIPTION

When an object moves through a fluid, an interaction between the object and the fluid produces resultant forces called stresses at the object-fluid interface. These stresses, such as Reynolds stresses, result from various properties of the fluid such as pressure, temperature, velocity, viscosity etc. Reynolds stress and its vertical, longitudinal, and lateral components are helpful in analyzing and predicting effects of fluid-flow on the object. For example, a shear stress of the fluid causes a drag on the object, and a pressure force of the fluid causes drag and lift on the object.

Reynolds stress and its components can be calculated by solving equations of fluid-flow using computational fluid dynamics (CFD) computer programs. Most CFD computer programs utilize numerical methods such as finite element method, finite difference method etc. to simulate fluid-flow and to solve complex equations of fluid-flow.

In the finite element method, a flow field or a mesh is divided into a set of small fluid elements called cells. The number, size, and shape of the cells depend in part on flow geometry and flow conditions relative to the object. For example, a mesh representing fluid-flow over a hood of a moving automobile will be different than a mesh representing fluid-flow over a tail of a flying aircraft.

A structured mesh comprises regularly arranged cells while an unstructured mesh comprises irregularly arranged cells. Most fluid-flow problems involving automobiles, aircrafts, submarines etc. require using unstructured mesh systems. Specifically, most domains of turbulent fluid-flow in a vehicle environment have complex geometry. Therefore, a turbulence model that is capable of simulating turbulence in an unstructured mesh system is preferred.

Stimulated Small Scale SGS or SSSS modeling is a new approach to turbulence modeling of Large Eddy Simulation (LES) where SGS is Subgrid Scale in LES. In SSSS modeling, components of Reynolds stress tensor such as u, v, w, T etc. are directly calculated without computing empirical coefficients.

Specifically, a relationship between filtered and unfiltered values of velocity, pressure, temperature etc. is directly calculated using a general mathematical method based on Taylor series expansion. Then a second order correlation of small scale values, which are differences between filtered and unfiltered values, such as Reynolds stress is directly calculated. Particularly, no empirical coefficients, hypotheses, or approximations are used.

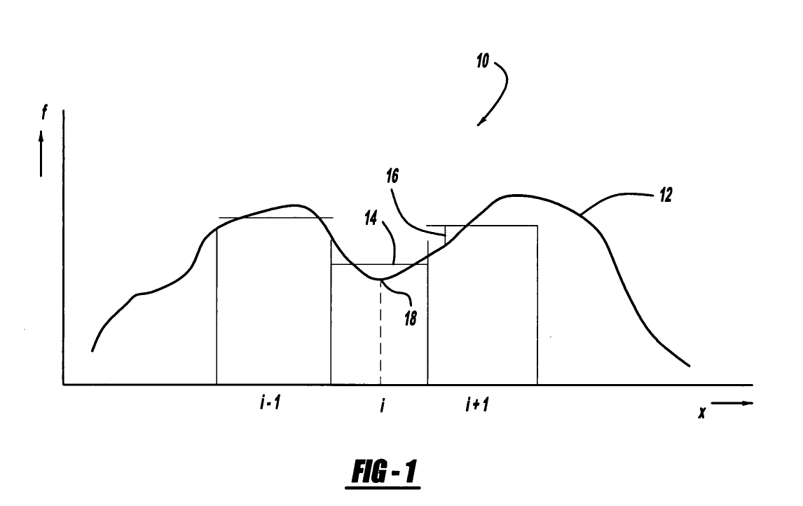

Basically, the SSSS model comprises stimulating unfiltered values from filtered values. Referring now to FIG. 1, a method 10 for stimulating unfiltered values is shown. In a one-dimensional case, a curve f(x) 12 represents a physical value f as a function of a coordinate x. ƒ̅ᵢ 14 is a filtered value of f over mesh i. f′ 16 is a difference between f and ƒ̅, i.e., a small scale value of f. ƒᵢ* 18 is value of f at center of mesh i.

Using Taylor series expansion, we get

$$f ( x ) = {f}_{i}^{*} + {( \frac{ⅆ f}{ⅆ x} )}_{i}^{*} ( x - {x}_{i} ) + \frac{1}{2 !} {( \frac{{ⅆ}^{2} f}{ⅆ {x}^{2}} )}_{i}^{*} {( x - {x}_{i} )}^{2} + …$$

$${where \\ ( \frac{ⅆ f}{ⅆ x} )}_{i}^{*} \approx \frac{1}{2} ( \frac{{f}_{i}^{*} - {f}_{i - 1}^{*}}{{x}_{i} - {x}_{i - 1}} + \frac{{f}_{i + 1}^{*} - {f}_{i}^{*}}{{x}_{i + 1} - {x}_{i}} ) \\$$

$${( \frac{{ⅆ}^{2} f}{ⅆ {x}^{2}} )}_{i}^{*} \approx \frac{( \frac{{f}_{i + 1}^{*} - {f}_{i}^{*}}{{x}_{i + 1} - {x}_{i}} - \frac{{f}_{i}^{*} - {f}_{i - 1}^{*}}{{x}_{i} - {x}_{i - 1}} )}{( \frac{( {x}_{i + 1} - {x}_{i} ) - ( {x}_{i} - {x}_{i - 1} )}{2} )}$$

and so on.

A filtered value of f(x) over mesh i is obtained using the following equation.

$$\begin{matrix}{\overline{f}}_{i} = \frac{1}{{Δ}_{i}} {\int }_{{Δ}_{i}} f ( x ) ⅆ x = {a}_{i} {f}_{i - 1}^{*} + {b}_{i} {f}_{i}^{*} + {c}_{i} {f}_{i + 1}^{*} \\ where \\ a = \frac{{h}_{i}^{2} ( {m}^{2} - 3 m ) + {h}_{i} {h}_{i - 1} ( 3 m - {m}^{2} ) + {h}_{i - 1}^{2} {m}^{2}}{12 {h}_{i - 1} ( {h}_{i} + {h}_{i - 1} )} \\ c = \frac{{h}_{i - 1}^{2} ( {m}^{2} - 3 m ) + {h}_{i} {h}_{i - 1} ( 3 m - {m}^{2} ) + {h}_{i}^{2} {m}^{2}}{12 {h}_{i - 1} ( {h}_{i} + {h}_{i - 1} )} \\ b = 1 - a - c \\ {h}_{i} = {x}_{i + 1} - {x}_{i} \\ m = \frac{( {Δ}_{i} + {Δ}_{i + 1} )}{( {h}_{i} + {h}_{i + 1} )}\end{matrix}$$

aᵢ, bᵢ, cᵢ depend only on mesh geometry. This equation shows a linear relationship between filtered and unfiltered values.

Combining the equations for all meshes, a linear algebraic equation system called a tri-diagonal system is obtained as follows.
ƒ̅=Lₓƒ*

For a three-dimensional case using a Cartesian mesh system, the following equations are obtained.
ƒ̅=L_{z}L_{y}Lₓƒ*ƒ*=L_{z}⁻¹L_{y}⁻¹L_{z}⁻¹ ƒ̅
i.e.
ƒ̅=Lƒ*ƒ*=L⁻¹ ƒ̅

Using these equations, small scale values and corresponding correlation values are calculated as follows.

$$\begin{matrix}{f}^{*} = {L}^{- 1} \overline{f} \\ {f}^{′} = {f}^{*} - \overline{f} \\ \overline{{f}^{′} {g}^{′}} = \overline{{f}^{*} {g}^{*}} - \overline{f} \overline{g}\end{matrix} \begin{matrix}{g}^{*} = {L}^{- 1} \overline{g} \\ {g}^{′} = {g}^{*} - \overline{g}\end{matrix}$$

These correlation values are Quasi-Reynolds stresses in Large Eddy Simulation, which are calculated by using the turbulence model according to the present invention. Because the linear operator L is related only to the mesh geometry, the stimulating process for any physical value is identical. Therefore, this model is simple and general.

If the three-dimensional mesh system is a structured body fit system instead of a Cartesian system, the mesh system is first transformed into a Cartesian system to obtain correlation values. Then the mesh system is transformed back to the structured body fit system.

For example, a tensor transform to obtain Reynolds stresses is represented by following equation.

$$( \begin{matrix}{τ}_{11} & {τ}_{12} & {τ}_{13} \\ {τ}_{21} & {τ}_{22} & {τ}_{23} \\ {τ}_{31} & {τ}_{32} & {τ}_{33}\end{matrix} ) = ( \begin{matrix}{x}_{ξ} & {x}_{η} & {x}_{} \\ {y}_{ξ} & {y}_{η} & {y}_{} \\ {z}_{ξ} & {z}_{η} & {z}_{}\end{matrix} ) ( \begin{matrix}{T}_{11} & {T}_{12} & {T}_{13} \\ {T}_{21} & {T}_{22} & {T}_{23} \\ {T}_{31} & {T}_{32} & {T}_{33}\end{matrix} ) ( \begin{matrix}{x}_{ξ} & {y}_{ξ} & {z}_{ξ} \\ {x}_{η} & {y}_{η} & {z}_{η} \\ {x}_{} & {y}_{} & {z}_{}\end{matrix} )$$

where Tᵢⱼ= u̅ᵢ̅′̅u̅ⱼ̅′̅ (i, j=1,2,3) is a Cartesian system (ξ, η, ζ), (x, y, z) is an original coordinate system, and τ₁₁= u̅ₓ̅′̅u̅ₓ̅ⁱ̅, τ₁₂= u̅ₓ̅′̅u̅_̅{̅y̅}̅ⁱ̅ etc.

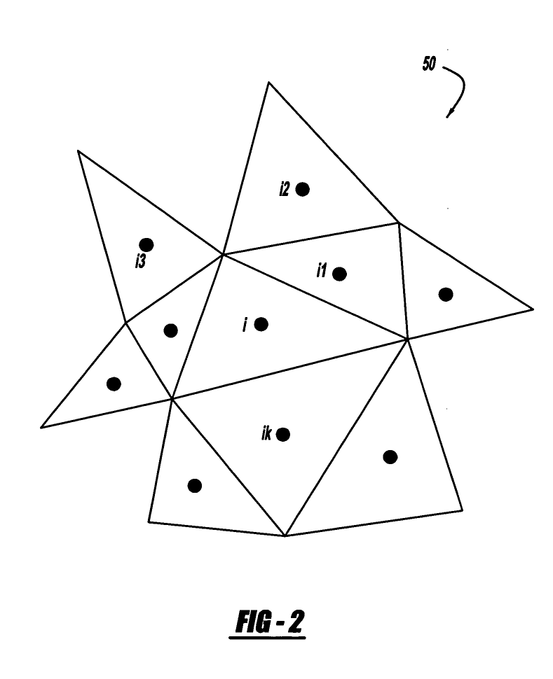

Referring now to FIG. 2, an unstructured mesh system 50 is shown. In Large Eddy Simulation of complex fluid-flow for the unstructured mesh system, calculating a linear operator between filtered and unfiltered values is more complex than the operator in the structured mesh system. A three-dimensional Taylor series expansion is used to directly obtain the linear operator L. This requires calculating three first order derivatives and six second order derivatives in x, y, z dimensions at the center of the mesh as shown in the following equation.

$$f ( x , y , z ) = {f}_{i}^{*} + {( \frac{\partial f}{\partial x} )}_{i}^{*} ( x - {x}_{i} ) + {( \frac{\partial f}{\partial y} )}_{i}^{*} ( y - {y}_{i} ) + {( \frac{\partial f}{\partial z} )}_{i}^{*} ( z - {z}_{i} ) + \frac{1}{2} [ {( \frac{{\partial }^{2} f}{\partial {x}^{2}} )}_{i}^{*} {( x - {x}_{i} )}^{2} + {( \frac{{\partial }^{2} f}{\partial {y}^{2}} )}_{i}^{*} {( y - {y}_{i} )}^{2} + {( \frac{{\partial }^{2} f}{\partial {z}^{2}} )}_{i}^{*} {( z - {z}_{i} )}^{2} ] + {( \frac{{\partial }^{2} f}{\partial x \partial y} )}_{i}^{*} ( x - {x}_{i} ) ( y - {y}_{i} ) + {( \frac{{\partial }^{2} f}{\partial y \partial z} )}_{i}^{*} ( y - {y}_{i} ) ( z - {z}_{i} ) + {( \frac{{\partial }^{2} f}{\partial x \partial z} )}_{i}^{*} ( x - {x}_{i} ) ( z - {z}_{i} ) + …$$

where all of the derivatives are linear functions of ƒᵢ*

Integrating the original value f(x,y,z) over mesh i, we get a filtered value ƒ̅ᵢ=Lᵢƒᵢ*, where Lᵢ is a linear operator at mesh i that depends only on the geometry of the mesh system. Combining all the lienear operators Lᵢ and the boundary conditions, a global linear operator L is obtained. Solving this linear equation system, the unfiltered values for all the meshes are obtained. Then the correlation values are directly calculated.

Specifically, the values of the derivatives at the centers of the mesh and the neighboring meshes can be calculated using the least square method as follows.

$$\begin{matrix}{E}_{i} = {\sum }_{k = 1}^{K} {( {f}_{ik} - {f}_{k} )}^{2} \\ = {\sum }_{K = 1}^{k} \{ {( \frac{\partial f}{\partial x} )}_{i} ( {x}_{k} - {x}_{i} ) + {( \frac{\partial f}{\partial y} )}_{i} ( {y}_{k} - {y}_{i} ) + \\ {( \frac{\partial f}{\partial z} )}_{i} ( {z}_{k} - {z}_{i} ) + \\ \frac{1}{2} {( \frac{{\partial }^{2} f}{\partial {x}^{2}} )}_{i} {( {x}_{k} - {x}_{i} )}^{2} + \frac{1}{2} {( \frac{{\partial }^{2} f}{\partial {y}^{2}} )}_{i} {( {y}_{k} - {y}_{i} )}^{2} + \\ \frac{1}{2} {( \frac{{\partial }^{2} f}{\partial {z}^{2}} )}_{i} {( {z}_{k} - {z}_{i} )}^{2} + {( \frac{{\partial }^{2} f}{\partial x \partial y} )}_{i} \\ ( {x}_{k} - {x}_{i} ) ( {y}_{k } - {y}_{i} ) + \\ {( \frac{{\partial }^{2} f}{\partial y \partial z} )}_{i} ( {y}_{k} - {y}_{i} ) ( {z}_{k} - {z}_{i} ) + \\ { {( \frac{{\partial }^{2} f}{\partial x \partial z} )}_{i} ( {x}_{k} - {x}_{i} ) ( {z}_{k} - {z}_{i} ) + {f}_{i} - {f}_{k} \}}^{2}\end{matrix}$$

Solving the equation

$${C}_{i} {D}_{i} = {\sum }_{k = 1}^{K} {f}_{k} {\vec{G}}_{ik} - {f}_{i} {\sum }_{k = 1}^{K} {\vec{G}}_{ik}$$

where Cᵢ is a 9×9 matrix related to {(xₖ−xᵢ), (yₖ−yᵢ), (zₖ−zᵢ)}

$$\begin{matrix}{D}_{i} = \{ {( \frac{\partial f}{\partial x} )}_{i} , {( \frac{\partial f}{\partial y} )}_{i} , {( \frac{\partial f}{\partial z} )}_{i} , {( \frac{{\partial }^{2} f}{\partial {x}^{2}} )}_{i} , {( \frac{{\partial }^{2} f}{\partial {y}^{2}} )}_{i} , \\ {= {( \frac{{\partial }^{2} f}{\partial {z}^{2}} )}_{i} , {( \frac{{\partial }^{2} f}{\partial x \partial y} )}_{i} , {( \frac{{\partial }^{2} f}{\partial y \partial z} )}_{i} , {( \frac{{\partial }^{2} f}{\partial x \partial z} )}_{i} \}}^{T}\end{matrix}$$

$$\begin{matrix}{\vec{G}}_{ik} = ( ( {x}_{k} - {x}_{i} ) , ( {y}_{k} - {y}_{i} ) , ( {z}_{k} - {z}_{i} ) , {( {x}_{k} - {x}_{i} )}^{2} , \\ {( {y}_{k} - {y}_{i} )}^{2} , {( {z}_{k} - {z}_{i} )}^{2} , ( {x}_{k} - {x}_{i} ) ( {y}_{k} - {y}_{i} ) , \\ { ( {y}_{k} - {y}_{i} ) ( {z}_{k} - {z}_{i} ) , ( {x}_{k} - {x}_{i} ) ( {z}_{k} - {z}_{i} ) \}}^{T}\end{matrix}$$

we get

$${D}_{i} = {\sum }_{k = 1}^{K} {f}_{k} \{ {C}_{i}^{- 1} {\vec{G}}_{ik} \} - {f}_{i} {\sum }_{k = 1}^{K} \{ {C}_{i}^{- 1} {\vec{G}}_{ik} \}$$

Substituting Dᵢ in the Taylor series expansion and averaging f(x, y, x) over the cell, we get

$$f ( x , y , z ) = {f}_{i} + \{ {\sum }_{k = 1}^{K} {f}_{k} {\{ {C}_{i}^{- 1} {\vec{G}}_{ik} \}}^{T} - {f}_{i} {\sum }_{k = 1}^{K} {\{ {C}_{i}^{- 1} {\vec{G}}_{ik} \}}^{T} \} \cdot {T}^{T}$$

$$where$$

$$T = \{ ( x - {x}_{i} ) , ( y - {y}_{i} ) , ( z - {z}_{i} ) , \\ \frac{1}{2} {( x - {x}_{i} )}^{2} , \frac{1}{2} {( y - {y}_{i} )}^{2} , \frac{1}{2} {( z - {z}_{i} )}^{2} , \\ ( x - {x}_{i} ) ( y - {y}_{i} ) , ( y - {y}_{i} ) ( z - {z}_{i} ) , ( x - {x}_{i} ) ( z - {z}_{i} ) \}$$

Integrating fᵢ(x, y, x) over mesh Δᵢ, we get

$${\overline{f}}_{i} = \frac{1}{{Δ}_{i}} {\int }_{{Δ}_{i}} {f}_{i} ( x , y , z ) ⅆ x ⅆ y ⅆ z = \\ {f}_{i} + \frac{1}{{Δ}_{i}} \{ {\sum }_{k = 1}^{K} {f}_{k} {\int }_{{Δ}_{i}} {[ {C}_{i}^{- 1} {\overline{G}}_{ik} ]}^{T} \cdot {T}^{T} ⅆ x ⅆ y ⅆ z - {f}_{i} {\sum }_{k = 1}^{K} {\int }_{{Δ}_{i}} {[ {C}_{i}^{- 1} {\overline{G}}_{ik} ]}^{T} \cdot {T}^{T} ⅆ x ⅆ y ⅆ {z}_{i} \} ⇒ {\overline{f}}_{i} = {f}_{i} + {\sum }_{k = 1}^{K} {c}_{ik} {f}_{k} - {f}_{i} {\sum }_{k = 1}^{K} {c}_{ik}$$

fᵢ can be obtained by solving the equation. This equation shows a relationship between the filtered value at cell i and the unfiltered values at the neighboring cells.

By collecting relationships for all the cells, a relationship between filtered and unfiltered values can be expressed as follows.
\vec{F̅}=LF*F*=L⁻¹\vec{F̅}
\vec{F̅}={ ƒ̅₁, ƒ̅₂, . . . , f̅ᵢ, . . . , ƒ̅₁}^{T}
F*={ƒ₁*, ƒ₂*, . . . , ƒᵢ*, . . . , ƒ₁*}^{T}
Thus, unfiltered values can be obtained directly from filtered values by using Taylor series expansion.

Then the second and third order correlation values can be obtained as follows.
F*=L⁻¹\vec{F̅} G*=L⁻¹\vec{G̅} H*=L⁻¹\vec{H̅}
F̅*̅G̅*̅=L[(L⁻¹\vec{F̅})(L⁻¹\vec{G̅})]
F̅*̅G̅*̅H̅*̅=L[(L⁻¹\vec{F̅})(L⁻¹\vec{G̅})(L⁻¹\vec{H̅})]

As can be appreciated, Reynolds stresses can be directly calculated using Taylor series expansion without using coefficients or hypotheses. Therefore, the SSSS model can be readily utilized in numerical simulation of various complex turbulent fluid-flow systems. The SSSS model is particularly useful in solving industrial problems involving unstructured mesh systems of varying and complex geometry.

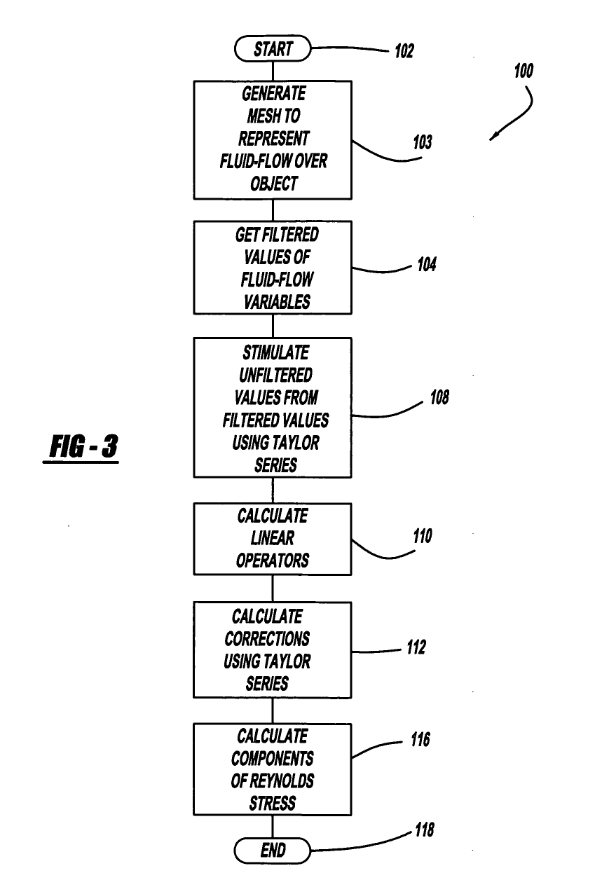

Referring now to FIG. 3, an algorithm 100 for stimulated modeling according to the present invention is shown. The algorithm 100 begins at step 102. A mesh is generated to represent a fluid-flow over an object in step 103. Filtered values of fluid-flow variables are obtained in step 104.

Using Taylor series, unfiltered values of the fluid-flow variables are stimulated from the filtered values in step 108. Linear operators between the unfiltered and filtered values are calculated using Taylor series in step 110. Correlations between unfiltered and filtered values are calculated using Taylor series in step 112. Components of Reynolds stress are calculated in step 116. The algorithm ends in step 118.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for stimulated modeling, comprising:
measuring filtered values of fluid-flow variables for an object;
stimulating unfiltered values of said fluid-flow variables based on said filtered values;
calculating correlations of differences between said filtered values and said unfiltered values;
calculating components of Reynolds stress based on said correlations; and
predicting effects of fluid-flow on said object based on said components of said Reynolds stress.

2. The method of claim 1 further comprising generating an unstructured mesh to represent fluid-flow over said object.

3. The method of claim 1 wherein said unfiltered values are stimulated using Taylor series.

4. The method of claim 1 wherein said correlations are calculated using Taylor series.

5. The method of claim 1 wherein linear operators between said unfiltered values and said filtered values are calculated using Taylor series.

6. The method of claim 1 wherein said object comprises a vehicle and said effects comprise fuel efficiency, lift, drag, aerodynamic stability, noise, vibration, and harshness.
